(19) United States
(12) Patent Application Publication
(10) Pub. No.: US 2014/0361589 A1
(43) Pub. Date: Dec. 11, 2014

(54) BABY CAR SEAT WITH A TWO-USE RELEASE MECHANISM

(71) Applicant: LERADO (ZHONG SHAN) INDUSTRIAL CO., LTD., ZHONG SHAN CITY (CN)

(72) Inventors: HUNG-CHUNG HOU, TAI-BAU CITY (TW); YU-TE CHOU, CHIAYI COUNTY (TW); JEN-EN HOU, PUZIH CITY (TW); HSIN-FENG LIN, TAIBAO CITY (TW); YU-LE LIN, YUNLIN COUNTY (TW)

(21) Appl. No.: 13/946,643

(22) Filed: Jul. 19, 2013

(30) Foreign Application Priority Data
Jun. 7, 2013 (CN) 201320326966.5

(51) Int. Cl. B60N 2/28

(52) U.S. Cl. CPC B60N 2/2821
USPC 297/256.16

(57) ABSTRACT

A baby car seat with a two-use release mechanism includes a baby car seat releasable from a mobile rack and base by pulling a handle in same place and same direction at one end of the baby car seat. The baby car seat is equipped with a set of first hooks for releasably anchoring on a mobile rack to use as a baby seat-stroller, a set of anchor rods for engaging by a set of second hooks 31 to be connected to a base for installing on a vehicle seat without the troublesome of tying and untying safety seat in the vehicle, and a set of sliding shifters for disengaging the set of second hooks from the set of anchor rods so as to release baby car seat from the base.

### BACKGROUND OF THE INVENTION

1. Field of the Invention

The present invention relates to a baby car seat, especially to a baby car seat with a two-use release mechanism.

2. Description of the Related Art

Some of commercial available baby car seats are designed to be connectable to a mobile rack to use as a baby seat-stroller, and mountable on a vehicle seat via a base for saving the troublesome of tying and untying safety seat in the vehicle.

As the connecting and release mechanism are operatively independently, the user has to study and find the release mechanism before start to use it. Hence this is not user-friendly, and we need to redesign the baby car seats.

### SUMMARY OF THE INVENTION

To improve the above-mentioned commercial available baby car seats, the present provides a baby car seat with a two-use release mechanism which includes a baby car seat engageable to and releasable from a mobile rack and base by pulling a handle in same place and same direction at one end of the baby car seat.

The baby car seat is equipped with a set of first hooks for releasably anchoring on a mobile rack to use as a baby seat-stroller, a set of anchor rods for engaging by a set of second hooks 31 to be connected to a base for installing on a vehicle seat without the troublesome of tying and untying safety seat in the vehicle, and a set of sliding shifters for disengaging the set of second hooks from the set of anchor rods so as to release baby car seat from the base.

By this mechanism, the user can release the baby car seat from the mobile rack and the base by pulling a handle at one end in same place and same direction at one end.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is an exploded perspective assembly view schematically showing an embodiment of the baby car seat according to the present invention is capable of disengaging from a mobile rack by pull a handle from the rear end thereof.

FIG. 2 is an exploded perspective assembly view schematically showing an embodiment of the baby car seat according to the present invention is capable of disengaging from a base by pull the same handle from the rear end thereof.

FIG. 3 is a rear-left perspective view of the embodiment of the baby car seat.

FIG. 4 is an exploded perspective view of the embodiment of the baby car seat.

FIG. 5 is a cross-sectional view schematically showing the operation for disengaging the baby car seat from the base.

FIG. 6 is a fragmentary cross-sectional view schematically showing the engagement between the baby car seat and the mobile rack.

FIG. 7 is a fragmentary cross-sectional view schematically showing the operation for disengaging the baby car seat from the mobile rack by pulling the same handle as being illustrated in FIGS. 1 and 3.

### DETAILED DESCRIPTION OF THE PREFERRED EMBODIMENTS

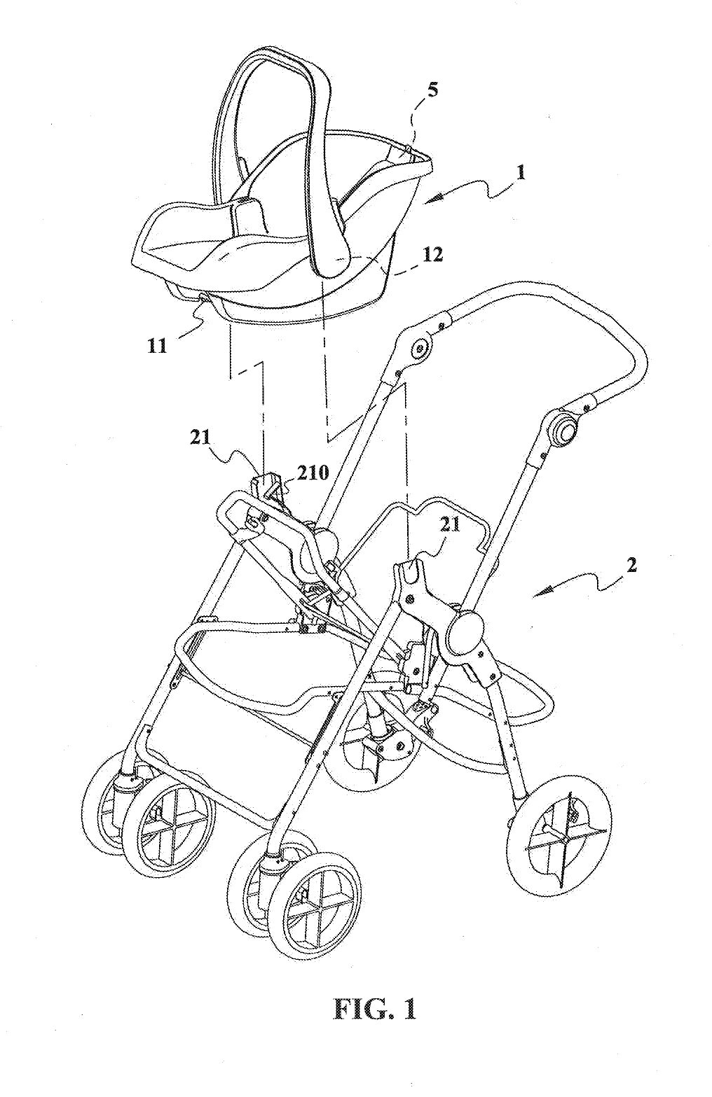

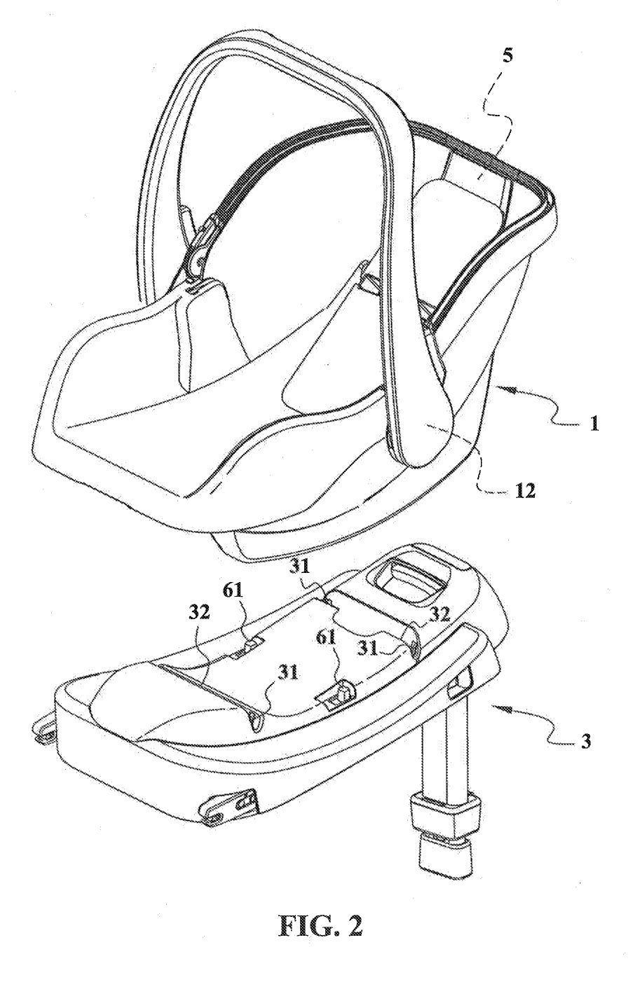

Referring to FIGS. 1 and 2, an embodiment of the baby car seat with a two-use release mechanism according to the present invention includes a baby car seat 1 which is releasable from a mobile rack 2 and base 3 by pulling a handle 5 in same place and same direction at one end.

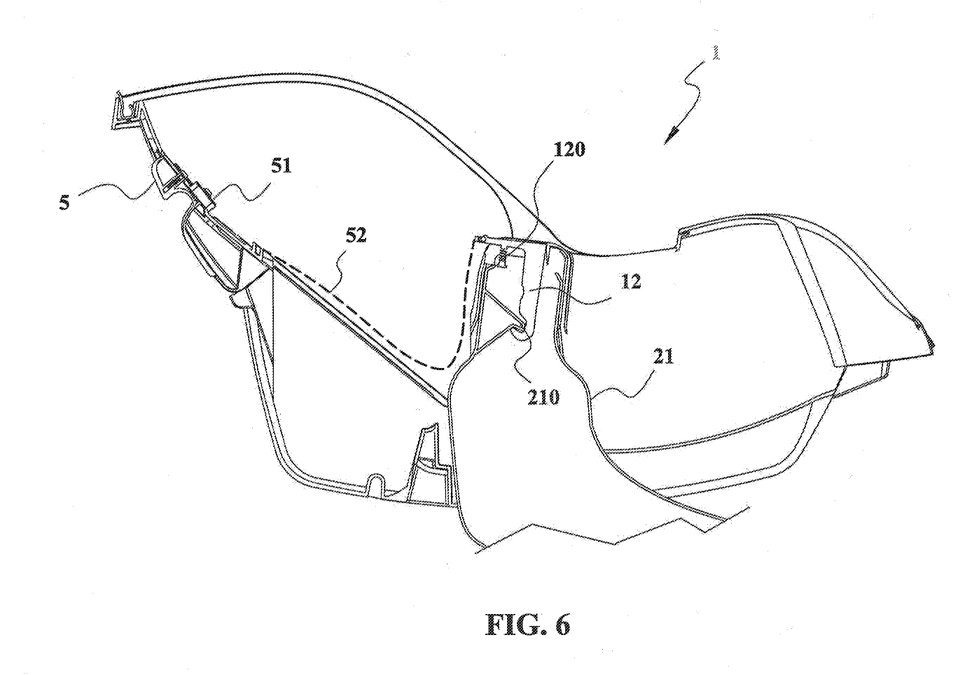

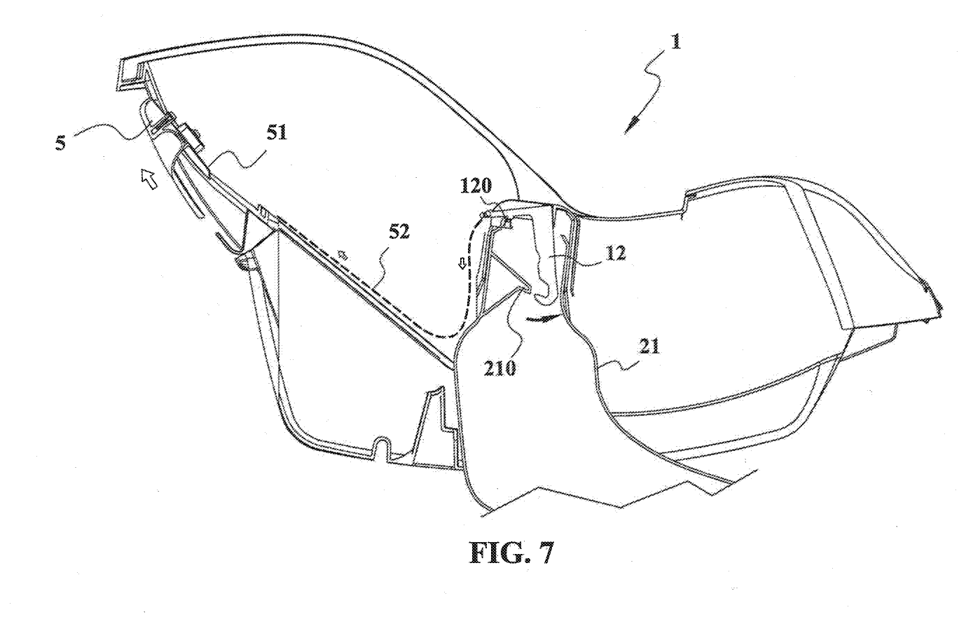

Referring to FIGS. 6 and 7, the baby car seat 1 is equipped with a set of first hooks 12 for releasably anchoring on a mobile rack 2 so as to use as a baby seat-stroller, a set of anchor rods 11 for engaging by a set of second hooks 31 so as to be connected to a base 3 for installing on a vehicle seat without the troublesome of tying and untying safety seat in the vehicle, and a set of sliding shifters 4 for disengaging the set of second hooks 31 from the set of anchor rods 11 so as to release baby car seat 1 from the base 3.

The set of anchor rods 11 may be embodied as a pair of metal rods spaced apart from each other, and the base 3 is formed with a pair of slots 32 respective to the pair of metal rods, and the pair of metal rods can insert into the pair of slots 32 and hooked by the set of second hooks 31.

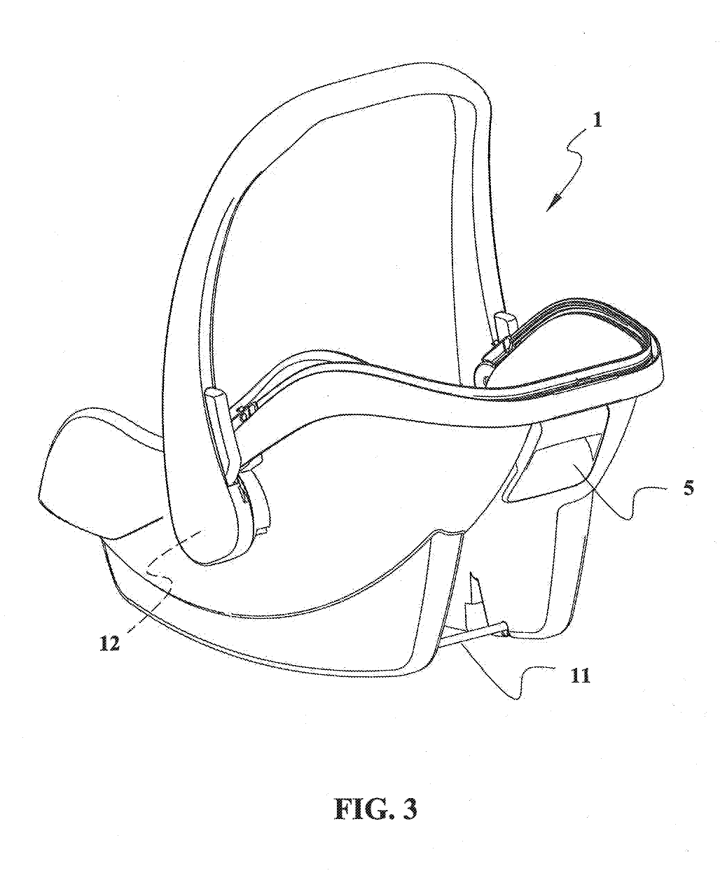

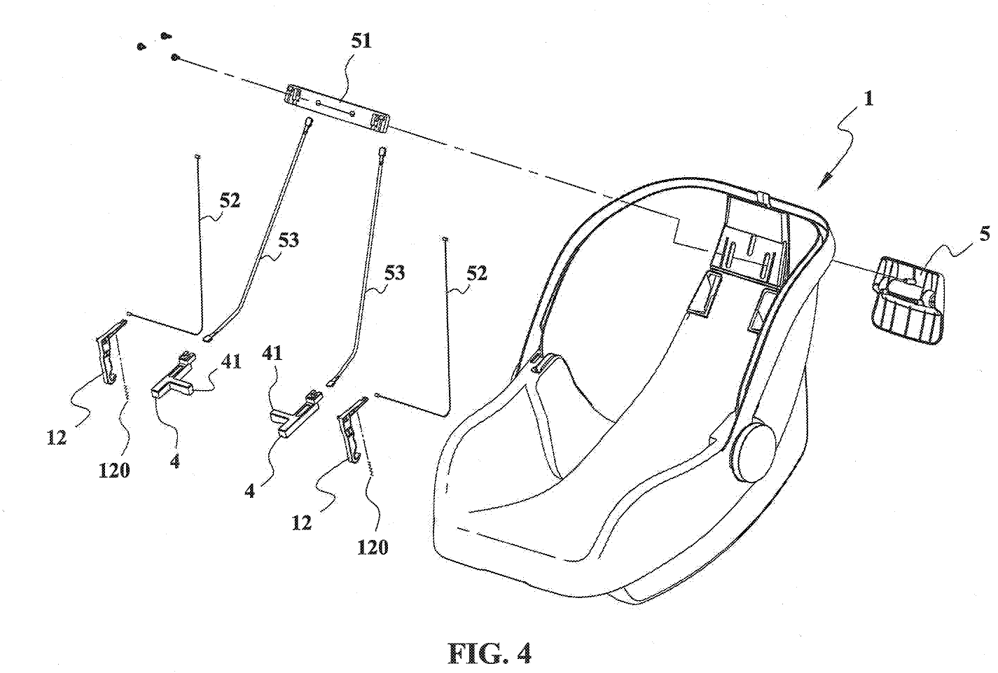

Referring to FIGS. 3 and 4, the handle 5 is associated with the set of first hooks 12 and the set of sliding shifters 4 by a driving element 51 and a set of first flexible connecting element 52 and a set of second flexible connecting element 53.

Preferable, each of the set of first hooks 12 may be biased by a resilient element 120 to a position of anchoring on the mobile rack 2.

The mobile rack 2 is provided with a set of sockets 21 for connecting the baby car seat 1 thereupon, and the sockets 21 each has an inner space provided with a hook retaining lug 210, and wherein the set of first hooks 12 can insert into the set of sockets 21 to hook on the hook retaining lug 210.

The hook retaining lug 210 may be formed with the sockets 21 integrally. The hook retaining lug 210 may also be a metal part connected inside the sockets 21.

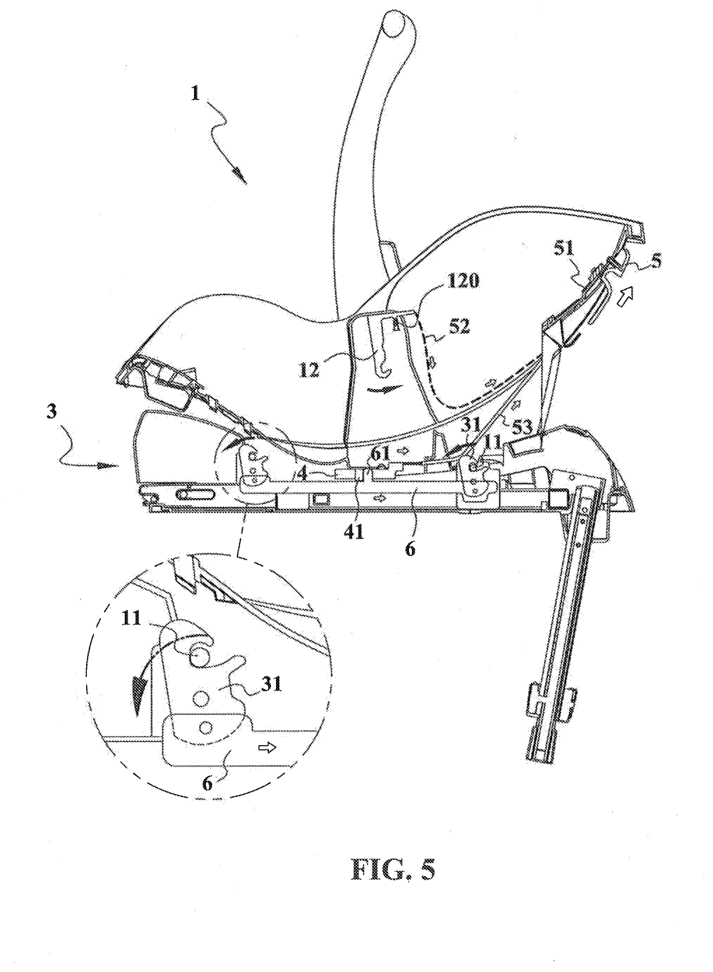

Referring to FIG. 5, the set of second hooks 31 may include a plurality of second hooks 31 pivoted inside the base 3 and spaced apart from each other, and capable of extending into the pair of slots 32 to hook on the set of anchor rods 11.

The plurality of second hooks 31 is associated by at least an associating element 6 and biased by a spring (not shown) either directly or indirectly so as kept to anchor on the set of anchor rods 11. The associating element 6 may be formed with a release actuator 61 which capable of contacting with the set of sliding shifters 4.

In this embodiment, the release actuator 61 is an outward protrusion formed on the associating element 6 for driving the associating element 6 to rotate the plurality of second hooks 31. Further, each of the set of sliding shifters 4 may be formed with a side extension 41 for pushing the associating element 6 so as to rotate the plurality of second hooks 31.

The handle 5 is operatively mounted at one end of the baby car seat 1 and being associated with the set of first hooks 12 and the set of sliding shifters 4. When the handle 5 is pulled, the set of sliding shifters 4 is pushing the associating element 6 to rotate the plurality of second hooks 31 to release the set of anchor rods 11.

Preferably, the handle 5 may be operatively installed on outside of the rear end of baby car seat 1. By pulling of the handle , the set of first hooks 12 and the set of sliding shifters 4 can be driven to move to a release position simultaneously.

By this mechanism, provides the user the possibility to release the baby car seat 1 from the mobile rack 2 and base 3 by pulling a handle 5 in same place and same direction at one end.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A baby car seat with a two-use release mechanism, including:
a baby car seat (1), having a set of first hooks (12) for releasably anchoring on a mobile rack (2), a set of anchor rods (11) for engaging by a set of second hooks (31) so as to be connected to a base (3), and a set of sliding shifters (4) for disengaging the set of second hooks (31) from the set of anchor rods (11) so as to release baby car seat (1) from the base (3);
a handle (5) operatively mounted at one end of the baby car seat (1) and being associated with the set of first hooks (12) and the set of sliding shifters (4); by pulling of the handle (5), the set of first hooks (12) and the set of sliding shifters (4) can be driven by the handle (5) to move to a release position simultaneously.

2. The baby car seat with a two-use release mechanism of claim 1, wherein the handle (5) is associated with the set of first hooks (12) and the set of sliding shifters (4) by a driving element (51) and a set of first flexible connecting element (52) and a set of second flexible connecting element (53).

3. The baby car seat with a two-use release mechanism of claim 1, wherein each of the set of first hooks (12) is biased by a resilient element (120) to a position of anchoring on the mobile rack (2).

4. The baby car seat with a two-use release mechanism of claim 1, wherein the mobile rack (2) is provided with a set of sockets (21) for connecting the baby car seat (1) thereupon, and the sockets (21) each has an inner space provided with a hook retaining lug (210), and wherein the set of first hooks (12) can insert into the set of sockets (21) to hook on the hook retaining lug (210).

5. The baby car seat with a two-use release mechanism of claim 1, wherein the handle (5) is operatively installed on outside of the rear end of baby car seat (1).

6. The baby car seat with a two-use release mechanism of claim 1, wherein the set of anchor rods (11) is a pair of metal rods spaced apart from each other, and the base (3) is formed with a pair of slots (32) respective to the pair of metal rods, and the pair of metal rods can insert into the pair of slots (32) and hooked by the set of second hooks (31).

7. The baby car seat with a two-use release mechanism of claim 6, wherein the set of second hooks (31) includes a plurality of second hooks (31) being pivoted inside the base (3) and spaced apart from each other, and capable of extending into the pair of slots (32) to hook on the set of anchor rods (11).

8. The baby car seat with a two-use release mechanism of claim 7, wherein the plurality of second hooks (31) is associated by at least an associating element (6), and the associating element (6) is formed with a release actuator (61) which capable of contacting with the set of sliding shifters (4); when the handle (5) is pulled, the set of sliding shifters (4) is pushing the associating element (6) to rotate the plurality of second hooks (31) to release the set of anchor rods (11).

9. The baby car seat with a two-use release mechanism of claim 8, wherein the release actuator (61) is an outward protrusion formed on the associating element (6) for driving the associating element (6) to rotate the plurality of second hooks (31).

10. The baby car seat with a two-use release mechanism of claim 8, wherein the set of sliding shifters (4) each is formed with a side extension (41) for pushing the associating element (6) to rotate the plurality of second hooks (31).
